(19) United States
(12) Patent Application Publication
(10) Pub. No.: US 2025/0075493 A1
(43) Pub. Date: Mar. 6, 2025

(54) Systems and Methods for Construction Panel Production

(71) Applicant: Resia IP Holding, LLC, Miami, FL (US)

(72) Inventor: Ernesto Lopes, Miami, FL (US)

(21) Appl. No.: 18/827,227

(22) Filed: Sep. 6, 2024

Related U.S. Application Data
(60) Provisional application No. 63/536,861, filed on Sep. 6, 2023.

(51) Int. Cl. E04B 1/76; B32B 7/12; B32B 9/04; B32B 9/06; B32B 37/00; B32B 37/12; E04B 1/80

(52) U.S. Cl. CPC E04B 1/7608; B32B 7/12; B32B 9/047; B32B 9/06; B32B 37/0053; B32B 37/1207; E04B 1/80; B32B 2037/1215; B32B 2307/3065

(57) ABSTRACT

A prefabricated construction panel is provided, the construction panel including one or more of the following: a first layer including a fiberboard construction panel; a second layer including a layer of hot melt; and a third layer including a panel of fire-retardant material. Related methods and means for assembly, installation, field use, and quality and safety control are also provided.

### STATEMENT OF RELATED CASES

The instant U.S. non-provisional application claims the benefit of underlying U.S. provisional application No. 63/536,861, filed Sep. 6, 2023, the entirety of which is included and otherwise incorporated by reference.

### FIELD OF THE INVENTION

The present invention relates generally to prefabricated construction panels used in residential and commercial building applications, and, in a specific though non-limiting embodiment to improved systems and methods of producing strong, durable, lightweight, fire-retardant construction panels used to build modularized structures such as houses, apartments and office buildings.

### BACKGROUND OF THE INVENTION

Strong communities tend to share certain common characteristics, for example, access to high-quality schools, transportation systems, employment opportunities, and recreation and entertainment facilities. Meanwhile, a severe housing shortage has arisen across the country that impairs the development of such communities, attributable primarily to a combination of financial factors, materials shortages, and a declining skilled labor force.

Builders have therefore been seeking solutions to these shortages in an effort to provide quality, affordable housing on a more time-and cost-effective basis. In particular, builders have found that by incorporating certain prefabricated components off-site, materials can be concentrated in locations established for centralized production, and fewer personnel are required to assemble the components for delivery to one or more construction sites.

However, the current prefabrication model is in reality plagued by inefficiencies, safety concerns, excess personnel requirements, and questionable building practices and materials.

For example, in conventional off-site construction methods, modular structures such as kitchens and bathrooms are typically constructed using standard drywall and steel studs to form the walls and ceilings of the structures, essentially mirroring the procedures employed at the construction sites, though assembly is remotely performed prior to the structures delivery to the job sites.

However, such methodologies prove to be time-intensive and require significant manual labor, and therefore a sizable work force to assemble and transport the structures is still required. Moreover, the ultimate buyer has no certainty regarding fire testing or the strength or durability of the building materials, and the resulting assemblies tend to be large, heavy, bulky structures that lend only modest improvement over current on-site practices.

There is, therefore, a long-felt but unmet need for systems and methods for producing prefabricated construction panels used, for example, in the construction of houses, apartments and office buildings, which overcome the shortcomings of the prior art. There is also a need for novel and proprietary systems and methods leveraging new technologies and building processes currently unknown in the construction field to offer safe, durable, fire-tested, and certified modular structures comprising a plurality of prefabricated construction panels assembled, tested and certified offsite for delivery to work sites on a vastly superior time-and cost-effective basis.

### SUMMARY OF THE INVENTION

The treated construction panels disclosed herein are safer, stronger, lighter, and more durable than traditional alternatives, and lend greater advantages in terms of automated manufacturing efficiency and field performance than any disclosed in the prior art.

In general, a completed panel comprises one or more of the following components: a substrate such as a fiberboard substrate, a hot melt layer, Magnesium Oxide (hereafter “MgO”) applied as a fire retardant, and/or panel surface coverings. Panels intended for different purposes will not always utilize all components. For example, ceiling, wall, floor, and exterior panels further comprise one or more panel coverings such as wallpaper, flooring, paint and/or sealant, whereas certain other interior panels will not typically require such treatment.

In a presently preferred embodiment, the prefabricated panels comprise three distinct formational elements, viz., a composite fiber substrate, a hot melt layer, and an MgO panel. In one embodiment, the MgO panel further comprises Magnesium Oxychloride (“MOC”).

In short, the disclosed construction panels and structures formed therefrom revolutionize commercial and residential construction by using a combination of robotics and other automated processes, thereby rendering an ideal selection for offsite manufacturing operations. The panels disclosed herein streamline production processes, reduce labor requirements, enhance construction quality and fire safety, and yield the affordable construction solutions required to meet the growing needs of our emerging communities.

### SUMMARY

A prefabricated construction panel is provided, the construction panel including one or more of the following: a first layer including a fiberboard construction panel; a second layer including a layer of hot melt; and a third layer including a panel of fire-retardant material. Related methods and means for assembly, installation, field use, and quality and safety control are also provided.

### BRIEF DESCRIPTION OF THE DRAWINGS

FIG. 1 is a flow chart illustrating systems and methods of a non-limiting example embodiment of a construction panel manufacturing system and method of use therefor according to the present invention.

FIG. 2 illustrates a partially coated, three-part construction panel according to the invention.

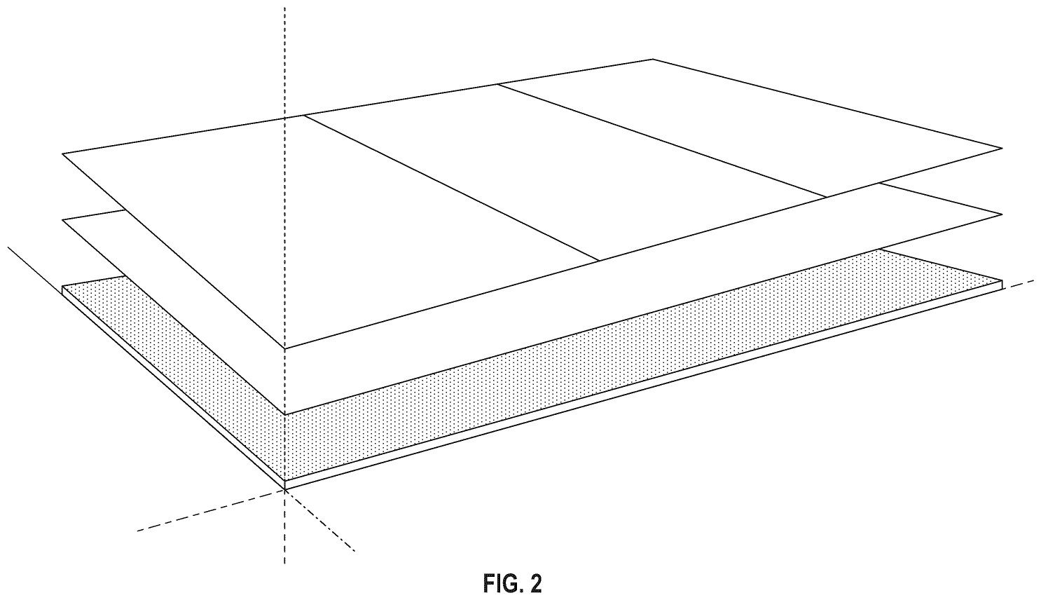

FIG. 3 is a flow chart illustrating systems and methods of assembling treated panels into modular structures according to the invention.

### DETAILED DESCRIPTION OF SEVERAL EXAMPLE EMBODIMENTS

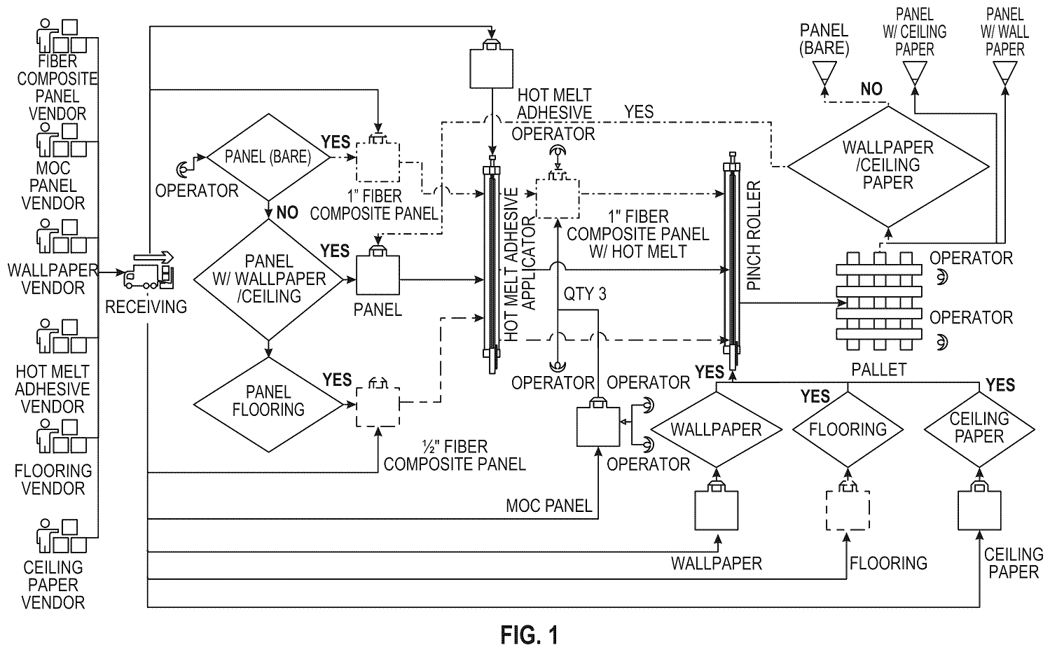

With reference now to the attached drawing sheet, FIG. 1 is a flow chart illustrating a non-limiting, example embodiment of a construction panel manufacturing system and method of use therefor according to the present invention.

In one example embodiment, one or more inbound freight systems deliver a plurality of boards suitable for use as a substrate of a fully treated, fire retardant construction panel by the end of the process disclosed herein. In a specific though non-limiting embodiment, the boards further comprise a fiberboard or a fiberboard composite material, or any other substrate material suitable for practicing the systems and methods disclosed herein, whether now known or later devised. In still further embodiments, the construction panels further comprise an MgO or MOC panel permanently adhered by a hot melt.

In further embodiments, other substrates comprising one or more of a differing composition, greater (or lesser) porosity, strength, fire retardation, and resistance to deformity & warping characteristics, etc., are used with approximately equal efficacy so long as the board is suitable for serving as the foundation for subsequently completed construction panels that otherwise meet the technical requirements for a given application.

In some embodiments, related construction panel necessaries such as hot melt compositions, sealants, paints, etc., are delivered together with (or at approximately the same time and in near spatial relationship to) the fiberboards delivery, so that materials required to act upon the fiberboards are delivered in close proximity to or concomitantly with the boards.

Note with hot melts in particular, the presently preferred embodiment uses a hot glue-like substance that relatively quickly sets and cures such that a fire-retardant panel can be pressed onto the hot melt and ultimately adhere to the fiber board substrate. Those of ordinary skill in the art will readily appreciate that other solutions such as chemically treated fiber boards, regardless of whether such treatment occurs on site or prior to delivery, will obviate the need for the hot melt so long as the chemical treatment solution carries out the adhesive platform required under the invention.

In one detailed embodiment, and with reference now to FIG. 1, a plurality of construction panel necessaries vendors fulfill and deliver (for example by truck or other suitable means) such necessaries to a construction panel production facility. Example construction panel vendors in various embodiments will comprise, non-exhaustively, one or more of a fiber composite panel vendor, MOC panel vendor, wallpaper vendor, hot melt adhesive vendor, flooring vendor, and/or ceiling paper vendor. Those of ordinary skill in the art will readily appreciate that many other supplies, machines, and so on will also reside within the scope of the instant disclosure.

After (or while) receiving and intaking the various materials delivered into the construction panel production center, operators sort the construction panels by intended use, each of which takes a different production track.

In general, there is no application of hot melt with nothing else on it, and a completely bare fiberboard would not typically be used in the construction process. In an alternative embodiment, a ½″ fiber composite board with hot melt and flooring, or a 1″ fiber composite board with hot melt and a MOC panel adhered, hot melt again and a paper (either wall or ceiling). A pinch roller serves to press the next relevant surface into the hot melt for bonding.

In some embodiments, the raw fiber 1″ composite board is then coated with hot melt, and MOC panels are manually placed on top of the hot melt and then run through the pinch roller. It is then taken back and recoated with hot melt, and then run through the pinch roller for paper application. In one specific example, the paper (whether wallpaper or ceiling paper) is applied to the hot melt using the pinch roller, so that the roller contacts the paper(s) but not the hot melt.

Finally, in some embodiments the one-half inch fiber composite board is coated with hot melt. Thereafter, the pinch roller applies flooring on the hot melt, such that the pinch roller contacts the flooring though not the hot melt; meanwhile, without being contacted by the pinch roller, the hot melt continues to set.

Panels made in the disclosed fashion, as further modified with the addition assembly processes described below, will provide structural, fire retardant, and insulative properties in one process, thereby eliminating the need for traditional framing or other coverings or treatments; can be used as a partition wall or combined with other such panels to create a self-supporting structure (subject to building usage and local requirements); post-processed via water jet to create the desired wall size and to create any needed internal penetrations for mechanical, electrical and/or plumbing (MEP) or other needs creating fully automated final wall generation; can be attached directly to the opposite side of another panel fully pre-assembled if there are no intervening structural members to traverse; and the MEP can be designed in such a manner that one panel/module can be attached to another or to an external entity via a single connection.

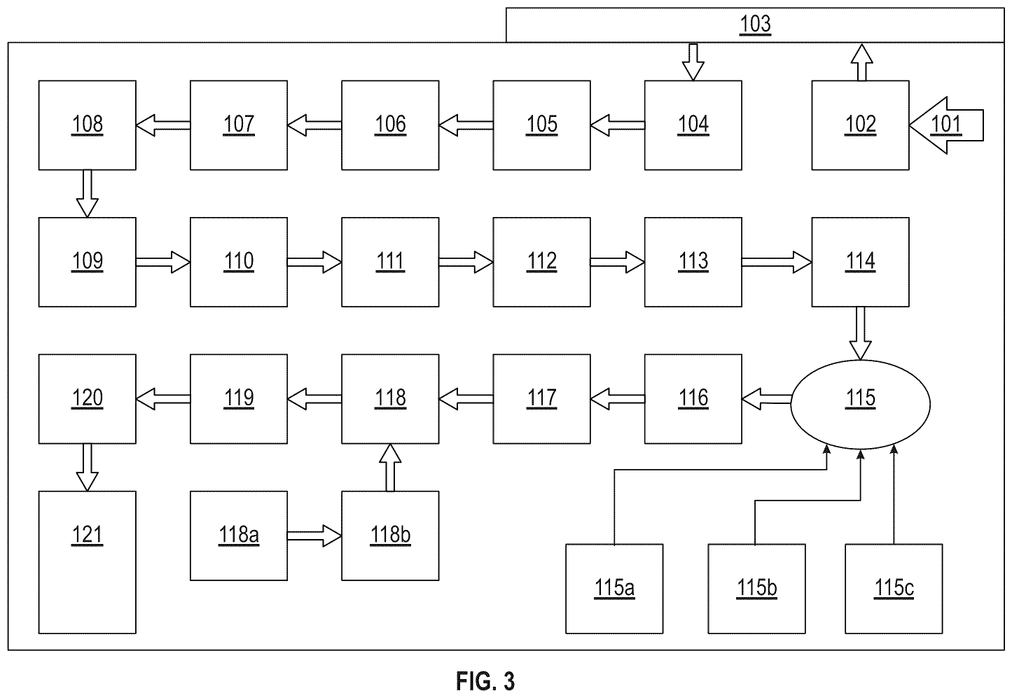

With the foregoing in mind, and with reference now to FIG. 3, in another embodiment, the fiberboards and/or related necessary materials are delivered to a central operations center for treatment and assembly. In some embodiments, an inbound freight transit system 101 delivers a plurality of boards measuring around eight feet by twelve feet to the central operations center, though ordinarily skilled artisans will appreciate that boards of greater or lesser dimensions also serve with equal efficacy provided they satisfy the technical requirements of a given application.

At present, truck delivery of boards to the central operations center is most common, though those of skill in the art will appreciate that alternative methods of delivery (e.g., train cars, water transit, etc.) serve the same purpose with equal efficacy, as will many other delivery systems, whether now known or future devised.

In example step 102, robotics unload the inbound freight and remove each piece, or a plurality of pieces, to a centralized inventory storage facility 103 (e.g., warehouse or other
suitable facility, etc.). However, human interaction, mobile vehicles (e.g., forklifts, etc.), or a combination of the same and/or other effective methods and means of accomplishing the task are also contemplated within the scope of the instant specification.

For purposes of this example, assume fiberboards measuring around eight feet by twelve feet are removed 104 from the warehouse and delivered to initiate automated treatment processes 105. As mentioned above, however, ordinarily skilled artisans will readily appreciate fiberboards comprising greater or lesser dimensions serve with equal efficacy depending on the specific application required for construction.

In example step 106, a robotic transfer unit acquires fiberboards either individually or collectively, and advances boards individually via robotics, overhead gantry automation, or another suitable method to a first adhesive machine 107, via robotics, conveyor belt, existing or customized gantries, and/or other conveyances, whether now known or future devised.

In one embodiment, first adhesive machine 107 initiates board treatment by applying a first hot melt to the fiberboard. In one example embodiment, the first hot melt further comprises a highly viscous hot glue, which coats the fiberboard, whether entirely or in part, though many other hot melts perform with equal efficacy so long as the hot melt adheres to or bonds with both the underlying fiberboard substrate and subsequently applied layers of fire-retardant sheets or spray on materials, e.g., MOC, etc.

In example step 108, robotics or other mechanical processes load and place fire-retardant materials upon hot melt applied to the fiber board. For purposes of the instant disclosure, the term load means to apply the fire-retardant materials to the fiberboard.

In one example embodiment, robot 108 loads 6 mm thick MOC panel to the fiber board by adherence or bonding the underlying hot melt together with the fiber board. Ordinarily skilled artisans will appreciate. however, that different fire-retardant materials, whether applied alone or in combination, serve with equal efficacy depending on the specific construction application, and different load thicknesses, setting times, etc., will naturally result from changes in materials and the requirements of a given application.

In example step 109, a first pinch roller applies pressure (and therefore heat) to the treated board; consequently, the fire-retardant material and underlying hot melt set. While the hot melt will set in minutes, full curing of the hot melt will take much longer, for example, twenty-four hours.

Those of ordinary skill in the art will appreciate that the first pinch roller of example step 109 is, in some embodiments, applied to the treated boards while still residing in the robotic fire-retardant materials loading station.

In example step 110, the set board advances to a second adhesive machine for application of a second hot melt to the combined set board. In one embodiment, the second hot melt comprises the same materials as the hot melt described with respect to first adhesive machine 107. In other embodiments, however, the second hot melt does not comprise the same materials as applied by the first adhesive machine 107.

In other embodiments, following a second application of hot melt, the boards migrate to a separate station, or run again through the first pinch roller, for pinch rolling and application of finishes (e.g., wallpaper, etc.) while the fire-retardant materials and hot melt strata fully set and adhere to the underlying fiberboard substrate. In still further embodiments, setting begins while the treated boards reside in the fire-retardant materials loading station, and then finishes curing at a separate station so that coating operations can continue in the fire-retardant materials loading station 108.

For example, those of skill in the art will appreciate that in instances where a given panel requires coverings 111 (e.g., wallpaper or paint on walls, etc.) it is convenient to apply a second hot, melt such as a highly viscous hot glue or the like to secure the finishing.

In other instances where such finishing is not required, it is convenient to apply a sealant or paint or the like in a separate application. Still further embodiments comprise other adhesive finishing materials, whether now known or future devised, depending on the requirements of a given application. In some embodiments, the fire-proofed panel (comprising a fiberboard, hot melt and MOC) is left bare as it will never be a shown surface, for example, if cabinets are to be installed over the surface or if an appliance will permanently cover the area.

Such preferences are engineering design decisions dictated by the specific application, and a theoretically infinite number of combinations of hot melt and fire-retardant materials are available to ordinarily skilled artisans, though corresponding temperatures and pressures sufficient to eliminate wallpaper seams and flooring expansion gaps are preferred.

In a presently preferred embodiment, the system comprises a single pinch roller through which panels requiring multiple treatments are fed one or more times in order to achieve the required results.

In a further embodiment, the now-finished boards advance to a second pinch roller 112, whether robotically or by conveyance, and heat and pressure applied to the boards finally cures the finishings. As before with respect to first pinch roller 109, in some embodiments pinch roller 112 applies pressure while the board still resides in the finishing station 111.

In other embodiments, second pinch roller 112 applies pressure to cure the finishings in a separate station, or, in still further embodiments in a combination thereof. Pressures and temperatures suitable for final curing are particular to the specific application, though in large-scale productions the pressures and temperatures required for final curing typically remain approximately constant.

After the finishings set, the combined and treated board advances, whether by robotics or conveyance, to one or more high pressure water jet stations 113. In one example embodiment, the water jets cut the treated boards to size when the desired final size is smaller than the originally delivered eight-foot by twelve-foot raw fiberboard.

For example, where it is desirous a final panel have dimensions of around four feet by eight feet, the water jets cut down the original size of the set treated board to the desired dimensions. In a further embodiment, all cuts required for either (or both) a treated panel or the resulting structure formed from a plurality of treated panels are performed.

In further embodiments, the water jets cut openings of various sizes and shapes in the boards to accommodate subsequently installed MEP kits 118 (hereafter “MEP”). In one non-limiting embodiment, high-pressure water jets having fluid flow pressures of around 91,000 psi reduce the size of the boards as needed, and form openings in the boards to accommodate the MEP kits 118. In other embodiments, the high-pressure water jets have fluid flow pressures either greater or less than around 91,000 psi, so long as sufficient fluid flow pressure is generated and maintained in a safe and controlled manner to effect the MEP kit technical requirements 114 for the particular application.

After water jets 113 cut the boards to size and form the MEP 118 kit openings to specification, the now completed construction panels advance, whether robotically or by conveyance, for delivery to a framing station 115 for initial detailing. Typically, the structure's walls frame at this point, though the walling process defers until after MEP kit installation, if desired.

In further embodiments, installation of various semi-permanent structures occurs within the framing station 115. For example, shower pans and tubs 115a, bathroom vanities 115b, toilets 115c, etc., each previously built-up offline, now install within the burgeoning structure, either robotically or by hand, typically (though not necessarily) all within the framing station. Ordinarily skilled artisans will appreciate, however, that according to other embodiments various installations can occur in separate framing stations or other workstations as desired.

In various embodiments the framed, typically walled, structures then transfer 116, whether robotically or by pallet or other human interaction, to a manual operations center 117 for completion and inspection. For example, human detailers will typically install a plurality of MEP kits 118, though this step also admits to robotic completion if desired.

The MEP kits are generally sub-assembled offline 118a and delivered 118b to the MEP kit installation station 118, the installation process comprising, inter alia, installing and sealing the required MEP components into the openings formed by the water jets in step 113. Finally, if the unit has not yet been walled pending completion of MEP kit installation, walling will now occur, The completed structure is now finished and otherwise ready for delivery to a job site as a single, unitary modularized structure. The structures forward to a quality control station 119, where every element is inspected and check-listed for maximum quality control.

In addition to the final checks there are often in-line quality verifications. For example, the PVC will go through a pressure test and the electrical kit goes through a HIPOT test prior to being installed on the structure in order to reduce redundancy and ensure safety.

In a still further embodiment, an operator of the inspection station; or an appropriate inspection officer or other agent or officer of an appropriately empowered, municipal, state or federal agency, or even another duly charged with the task, for example, a housing or building related agency requiring permit inspection and/or approval; and buyoffs on a completed system, essentially certifying and signing off on materials quality, fire safety, and construction methods, prior to delivery. Each unit receives a bar code that carries all certifications, design documents and required testing results for full traceability.

Finally, the completed unit is covered and/or wrapped and prepared for shipping 120. The completed, inspected, wrapped unit places in-line for outbound freight transit 121, much as discussed above with respect to the inbound freight transit in step 101, only now reversed since the structure is terminally exiting the facility.

The present invention depicted and described herein details several example embodiments. However, ordinarily skilled artisans in the relevant fields will readily appreciate that minor changes to the description and various other modifications, omissions, and additions are possible without departing from the spirit or scope of the instant disclosure.

1. A prefabricated construction panel, said construction panel comprising:
a first layer comprising a construction panel substrate;
a second layer comprising a layer of hot melt; and
a third layer comprising a panel of fire-retardant material.

2. The construction panel of claim 1, wherein said construction panel substrate further comprises a fiber board.

3. The construction panel of claim 2, wherein said fiber board further comprises a composite fiber board.

4. The construction panel of claim 1, wherein said fire retardant material further comprises Magnesium Oxide

5. The construction panel of claim 4, wherein said Magnesium Oxide further comprises a panel of Magnesium Oxychloride affixed upon said hot melt.

6. The construction panel of claim 5, wherein said panel of Magnesium Oxychloride is adhered to the first layer construction panel substrate using a pinch roller, such that said pinch roller contacts the Magnesium Oxychloride panel but not the intervening hot melt.

7. The construction panel of claim 6, wherein said fire-retardant panel further comprises an additional layer of hot melt disposed in communication with a paper layer finishing.

8. The construction panel of claim 7, wherein said paper finishing further comprises wallpaper.

9. The construction panel of claim 7, wherein said paper finishing further comprises ceiling paper.

10. A prefabricated construction panel, said construction panel comprising:
a first layer comprising a construction panel substrate; and
a second layer comprising a layer of hot melt.

11. The construction panel of claim 10, wherein said construction panel substrate further comprises a fiber board.

12. The construction panel of claim 11, wherein said fiber board further comprises a composite fiber board.

13. The construction panel of claim 12, wherein said construction panel is coated with a hot melt and finished with a floor covering adhered to the hot melt.
